(19) United States
(12) Patent Application Publication
(10) Pub. No.: US 2002/0194208 A1
(43) Pub. Date: Dec. 19, 2002

(54) Methods of managing the transfer, use, and importation of data

(76) Inventors: David C. Knoll, Lakeland, MN (US); Diane E. Morel, Shorewiew, MN (US)

Correspondence Address: Office of Intellectual Property Counsel, 3M Innovative Properties Company, PO Box 33427, St. Paul, MN, 55133-3427, US

(21) Appl. No.: 09/930,940

(22) Filed: Aug. 16, 2001

Related U.S. Application Data
(63) Continuation-in-part of application No. 09/882,969, filed on Jun. 15, 2001.

(51) Int. Cl. G06F 12/00

(52) U.S. Cl. 707/204

(57) ABSTRACT

Certain improvements related to the transfer and use of information are disclosed, including a the transfer of information from an existing database to a database used in conjunction with an RFID device of the type that may be used to interrogate RFID tags associated with items associated with entries in the existing database.

### RELATED APPLICATIONS

This is a continuation-in-part of U.S. application Ser. No. 09/882,969, filed Jun. 15, 2001.

### TECHNICAL FIELD

The present invention relates to improvements in methods of managing the transfer, use, and importation of data, and in one embodiment the transfer and subsequent use of data from an existing database having an arbitrary data management system to a selected data management system.

### BACKGROUND OF THE INVENTION

Many facilities have computers that include databases with entries describing multiple items. One example is a library, which typically has a computer with a database including entries for each library book, magazine, or other material possessed by the library. The database may be provided by a vendor, such as a library automation vendor. Those databases enable a library to access data related to one, a group of, or all of the materials in the library, as needed. For example, if a patron requests a particular book, the database can provide information regarding the circulation status of the book, such as the most recent date on which it was checked out, and other related information. These types of databases are common in other fields also, including asset tracking and management generally.

In some fields, there are a variety of databases that use file formats that are not inter-compatible, and thus retrieving information from the database of one system for use with other systems can be problematic. For example, a particular university library may have a database listing its materials that is different from the corresponding database that a particular public library maintains, which in turn may be different from the database that a particular junior high school library maintains. It therefore becomes difficult for equipment, software, service or other suppliers to interact effectively with each of these different databases without customizing those databases. Because manual customization, or entry or re-entry of the contents of an entire database can be an impossibly large task, there is a need for improvements in the transfer and use of information between different databases. That is the subject of the present invention.

### SUMMARY OF THE INVENTION

The present invention includes a variety of features described herein, including a method of transferring and using information, comprising the steps of obtaining information related to a plurality of items from an existing database; reformatting the information in a desired manner to facilitate the use of the information by an RFID reader; exporting the information to a database stored on a data storage device; and using the information on the data storage device with an RFID reader in conjunction with the interrogation of RFID tags associated with the items. Another embodiment of this invention comprises the steps of obtaining information related to a plurality of items from an existing database; reformatting the information in a desired manner to facilitate the use of the information by a system that is not compatible with the existing database; exporting the information to a database stored on a data storage device; and using the information on the data storage device with the system to process the items that are identified in a manner other than an RFID tagged manner. A combination of software for reformatting information obtained from an existing database having an arbitrary data management system into reformatted information stored in a database for use by an RFID reader, the databases comprising entries related to items of interest; and an RFID reader that interrogates RFID tags associated with items and transfers information related to the interrogated RFID-tagged item from the RFID reader to the database, from the database to the RFID reader, or both, is also disclosed.

The data transfer and management system of the present invention may be used in conjunction with devices such as a portable RFID reader, self-service terminals and staff workstations for processing tagged items, conversion stations, and other item processing devices. The system may be used not only in connection with RFID-tagged items, but also items that are associated with other item identifiers, such as barcodes, characters, handwritten indicia, and other types of identification.

The present invention, which typically uses lists or files created from an existing database, has several advantages over systems that attempt to provide direct access to an existing database. First, direct access systems require detailed knowledge of the structure of the existing database and how to create a connection to that database. Because the structures may differ based on the database, as described above, direct connections may be difficult to obtain. Second, direct access is relatively slow compared to file access (as used herein), because the existing database is generally on a different computer and requested data has to be separated from unrequested data within that database. Extraction into a file provides faster access than by direct query. Third, some existing databases may not support standard access, such as SQL access, but essentially all existing databases should be able to provide some kind of reporting features for generating list files.

The items that are the subject of the data may be assets of any kind, including library materials, criminal evidence, documents or files, containers, pallets, boxes, retail goods, rental items, video tapes, or laboratory samples.

These and other aspects of the present invention are described in greater detail below.

### DETAILED DESCRIPTION OF THE INVENTION

The present invention is described in some instances with reference to the management of data in the context of a library, and specifically in interacting with existing databases of the type described above. However, the usefulness of the present invention is not limited to the management of data in libraries, as will be evident from the following disclosure. The data transfer and management methods and systems of the present invention enable a user to extract data from an existing database, transfer them into a new database, reformat those data, and then use the reformatted data in a desired manner. Those and other aspects of the present invention will be described in detail below, and are also described in a publication entitled 3M Digital Data Manager Model 747 User Guide, a copy of which was submitted in an Information Disclosure Statement accompanying the present application, and the entire contents of which is incorporated by reference herein (hereinafter the “Data Manager User Guide”). Where additional information may be useful to supplement an understanding of the present invention, reference is made to the subject matter incorporated from the Data Manager User Guide. Although the following description is provided largely in the context of transferring information from an existing arbitrary database to a new database, the reverse processes can also be implemented to reformat information in a manner suitable for transfer to an existing database. Lastly, the terms “RFID device” and “RFID reader” are used in connection with the present invention, and both refer to a device that, at a minimum, is able to interrogate and obtain information from an REID tag. The RFID device or RFID reader may, depending on the context and the application, also be able to program or write information to the RFID tag, or even perform other functions.

Transfer and Use of Information

In one aspect of the invention, a method is provided for obtaining data from an existing database through a user interface (such as that provided on a personal computer), downloading the data to a new database, optimizing or reformatting those data in a way that enables a radio frequency identification (“RFID”) device to use the data, downloading the optimized or reformatted data to a non-volatile data storage medium, loading the data storage medium into an RFID device (preferably a portable, handheld RFID reader, though other non-handheld devices of the type mentioned below are also suitable), and then using the RFID device in conjunction with the data to obtain real-time feedback from the RFID device as to items having RFID tags that are interrogated by the RFID device. The RFID device may be an RFID reader (or interrogator) of the type referred to in the Data Manager User Guide as the Digital Library Assistant, or “DLA,” which is available from Minnesota Mining and Manufacturing Company of St. Paul, Minn. (“3M”). Additional information related to RFID devices of this type is available in, for example, U.S. Pat. No. 6,232,870 (Garber et al.), the contents of which is incorporated by reference herein, and from other manufacturers of RFID devices including Texas Instruments of Dallas, Tex.

A. Preparing Database Entries for Export

Data from a database may be prepared for eventual use by an RFID device, for example, in the following manner. The existing database is typically created and maintained on a personal computer or on a server, and may include thousands or millions of entries related to items of interest. First, folders may be created (in a Windows™ operating system environment, for example) that store files containing data extracted from the database. Those folders may be, for example, ones that contain files listing items in a specific order (such as the order in which books or files are supposed to be positioned on a shelf, or the order in which other assets are supposed to be positioned within a warehouse, or simply in order of their serial numbers), or ones that contain files with lists of items for which the user wishes to search (such as items thought to be missing, items that can be retrieved and discarded, items that a person wishes to retrieve for herself or another user, or other such things). These folders can reside on a hard drive, on a network drive, on a removable data storage medium, or on any type or combination of data storage media. Folders may be useful for storing multiple files that are related to each other, thereby linking files that describe common items, such as items located adjacent to each other within a storage area, or for other reasons. One reason that a user might choose to create multiple files that are linked in a folder is, for example, if a list file containing the records selected for use is quite large, then it may be useful to split that file into two or more files that can be stored within the same folder. Thus the ordered list folder may contain a first file having information identifying items that are supposed to be located on the first 100 locations within the storage area, a second file having information identifying items that are supposed to be located on the second 100 locations within the storage area, and so on. To prepare the data placed into the folders for transfer, an export location is designated. Typically the export location is a removable data storage device, such as a flash memory card, floppy disc, or the like. The export location may also be a hard drive or a network drive. There could also be multiple export locations for the same information.

Although it is preferred that the data manager not select the data directly from the existing database, but rather obtain data from a list of data selected by a user, the data manager could directly select the data from the existing database and place it into files as described above, or could select the data from the existing database based on a specified format of the existing data, or a user could create an intermediate database or text file with data in a specified format that the data manager can extract. In another embodiment that is particularly useful for data that may be updated or otherwise changed frequently, it may be more useful to create a specified query to be run by the data manager in the existing database than to obtain a single list file that may become outdated before it is used by the data manager. When the data manager prepares to use data from an existing database, it runs a query of that database to obtain a current list of the information that it will require, and thus obtains the most current data available from the existing database. The query in some cases could be run from a query file which would provide data searching and selection commands that are specific to the existing database, and thus would extract from that database information matching the query file selection instructions.

In the following example, the data stored in the files extracted from the existing database includes item identifiers (such as barcodes, characters, hand-written identifiers, or the like) associated with items. The item identifiers may be reformatted in a manner that makes them easy to read in a printed report, such as adding spaces and other formatting characters, though the added information may not form part of the actual item identifier. To validate the item identifier information from the existing database, a valid length parameter is assigned. For example, for barcodes the minimum barcode length may be 14 characters, and the maximum barcode length may be 16 characters, though other valid length parameters may be selected depending on the type and format of the item identifier(s) in the existing database. The length parameters could also be the same, so that only item identifiers of a specific length would be accepted. Valid characters are also designated, so that the data transfer system can recognize those characters and ignore all others. Examples of valid characters may include numeric digits (0 through 9), lower case letters (a through z), upper case letters (A through Z), or additional, user designated characters (such as one or more of the symbols !@#$%ˆ &*( )_+?><”:';}{][=−\|). The user may customize the data format by setting values for format configuration parameters. Data that do not meet the format configuration parameters can be identified, which is advantageous because it enables the data manager to inform a user, or create a log, concerning invalid item identifiers such as barcodes so that the user can correct these identifiers in the existing database.

In some instances, an item identifier provided on an item does not match the corresponding item identifier from the list file, and thus from the existing database record. When this occurs, it is necessary to alter the identifier of the item so that it corresponds to the identifier stored in the existing database. This is done using filters, which in the case of filters for barcodes are simply referred to as barcode filters. A filter such as a barcode filter consists of a group of instructions that can identify a specific barcode data format, and then change that format so that it matches the existing database data format. The filter instructions include conditions and actions. Conditions are requirements that must be met before the filter can be applied. For example, the required item identifier length is a condition. Another condition may be the existence of a specified string of characters in the item identifier. If an item identifier meets all of the conditions in the filter instructions, then the filter will apply all the actions contained in the filter instructions. For example, an action may be to find a specific character string in an item identifier such as a barcode and replace it with a desired character string. Other actions include adding specified characters, padding the item identifier on the leading or trailing end of the identifier, or both, until it reaches a specified length, adding a check digit computed using a selected algorithm, removing specified characters, or replacing specified characters. The data manager system provides a way to filter the item identifier so that the identifier read from the item will match the item identifier read from the list file. Additional information related to filtering, such as barcode filtering, is provided in the Data Manager User Guide incorporated by reference above.

The format in which the user's data exists, whether the data is in the user's existing database or in data files extracted from the existing database by the user, must be designated in order for the data manager to extract the data from the existing database or from the extracted data files. For example, the data format of files extracted from an existing database may be selected by the user from among a number of proposed formats provided by the data manager software package, or may be customized by the user. For example, the user may specify that each item record in an extracted file includes multiple lines of text, and that the records are separated by blank lines. Another format may include ones in which each record is provided on a single line, with a particular user-defined delimiter, such as a tab character, separating fields within the record. Yet another format may include ones in which each record is on a single line, and the field boundaries are defined by a fixed width, or number of characters. As a specific example of a data format, the user may specify that the first 12 lines of the database should be skipped, then that the item identifier starts at, for example, the 6^{th} character position on the second line of each item record and extends for 12 characters, and may also specify the locations of the primary and secondary information in the records. User-defined formats may be named, saved, edited, reused, specified as a potential default format for future use, or more than one of the foregoing. Concurrent with identifying the format of the files extracted from the existing database, the user may select the data to be displayed on an RFID device that is useful for an operator. For example, certain information from each database record may be designated for display on an RFID device as a primary information field, and other information from that database record may be designated for display as a secondary information field. Any number of information fields may be provided, and the corresponding information displayed for the user. For example, the user may wish to display on the first line of a display the name and/or title of an object or a portion of the name and/or title of an object, and to display on the second line of a display an identification number, call number, serial number and/or the equivalent or a portion of an identification number, call number, serial number and/or the equivalent. Those fields would be indicated as the primary and secondary information fields, respectively. Additional fields may also be designated relative to each database record, perhaps related to information about borrowing activity for each item, or the date of publication, or in the case of certain items the date the item was made or shipped, and that information may also be displayed for a user.

Another aspect of the data manager system of the present invention is the ability of the system to handle duplicate items, duplicate database records on a single list file, duplicate database records on different list files, or any combination of these issues. The data manager system can address duplicate items by comparing a primary or secondary information field (which might include an identification number, call number, or the like as described above), and then treating as duplicate entries those that match one or both of the primary and secondary information fields. Thus in general terms, the data manager identifies as a single item or type of item things that have differing item identifiers by, for example, comparing one or more information fields related to each entry to determine whether they are identical. For example, if a facility has multiple duplicate items, then the associated database may contain a corresponding number of substantially identical entries. This can occur in a library where, for example, 10 duplicate copies of a library book may be available for patrons, or in a warehouse where 10 identical products are all designated with the same identifying information. In this instance, then it may not matter to a user whether the duplicate items are in any particular order relative to each other, so long as they are all located together. When an ordered list of items (such as a list of items in the order they should be stored in a storage area) is prepared, the data manager assigns the same storage area location to each identical item. That way, none is considered by, for example, an RFID reader, to be out of position so long as it is located with other like items. Another manner of addressing the same situation is to designate a range of acceptable locations for each of the multiple items, and to instruct the data manager system that if the item is found somewhere within that range of positions, it should be considered to be in the correct position. Thus where there are ten identical items, and each can be located anywhere between shelf position 3395 and 3404, the data manager can be instructed to consider that to be a proper location.

The data manager may also address a situation where duplicate database records are on a single list file or duplicate database records are on different list files. If multiple database records exist in the same ordered list, or on more than one ordered list for the same storage area, this can assumed to be an error because an item cannot physically be in two or more locations at the same time. The data manager software can detect and report this, thus allowing the user to correct the mistake in the existing database.

Transferring large files extracted from an existing database to a new database using the data manager system and methods of the present invention can take a substantial period of time, particularly when a large number of database records are transferred. This time can be wasted if the database records are not properly transferred and formatted for the new database. A “preview file export” feature may be provided, so that prior to transferring 25,000 database records, for example, the first 1000 records can be displayed for the user to review before proceeding to export all the records. In the case of database records selected by the user as described above and stored in a file such as an ordered list for use by the data manager system, the preview file export feature may include fields including the storage area location (in numerical format, for example), the item identifier, call number or the like, the primary information field, the secondary information field, and any other fields desired by the user. Once the user has reviewed the files that have been previewed, the user can proceed to export the entire set of database records, or a subset, by initiating the appropriate commands.

B. Exporting Data

One or more data lists can be selected for export to a data storage device, such as a hard drive or, preferably, the removable data storage medium of the type referenced above. That data storage device may be non-volatile, an example of which is a compact-flash memory card, which is a solid-state data storage medium that can be inserted into and withdrawn from a compact flash drive or port. Additional information related to removable data storage media is provided in copending PCT Application No. PCT/US01/07979, filed Mar. 13, 2001 and entitled “Radio Frequency Identification Reader with Removable Media,” the contents of which is incorporated by reference herein.

In another embodiment, the data may be exported to a data storage device that is docked or otherwise connected (for example by a hardwired connection to a piece of hardware, or by a tethered connection to a piece of portable hardware) to the processor that exports the data, or could be transferred by wireless connection, all in a manner known in the art.

At the conclusion of the export, a summary log can be displayed for or made available to a user. The log may include a description of the files that were transferred, the number of records that were transferred, the elapsed time for the transfer, the number of errors encountered, error messages and warnings, and similar information. If errors are noted, then access may be provided to a detailed export or error log, which can describe the reason that an error was detected. For example, a database record may have been lacking information in a required field (such as the item identifier, call number, title, or the like), or have an invalid character, or the like. Or the extracted file(s) may contain multiple entries setting forth different positions that a single item is located within the library. This information is useful because the user can then correct the existing database, so that the integrity of the existing database is improved. Either the new or the existing database or both could then be searched to locate all entries with a particular type of error, such as the absence of an item identifier, or the absence of a name or title. When the export is complete, the new database containing the exported files may be transferred electronically, or a removable data storage medium may be withdrawn from a drive and inserted into another drive or port, for example.

The information formatted and exported from the data manager as described above can then be stored on the user's same computer, on a portable RFID device, or, preferably, on the removable data storage device through an appropriate docking station, all as described above. When that memory device is next inserted into the RFID reader, the reader is provided with access to data stored in a uniform manner, from which other operations of the reader can draw.

C. Importing Data Collected from Interrogated RFID Tags to an Existing Database

In another embodiment of the present invention, after data has been collected by an RFID reader by interrogation of RFID tags associated with items of interest, the data may be uploaded to an existing database. This may be done by a process similar to reversing the process described above for extracting data from an existing database, transferring the data to a new database and then reformatting those data so that the reformatted data can be used in a desired manner. That is, the collected data is uploaded from the database in which it is stored after collection by the RFID reader to the system on which the data manager is resident. The data manager reformats the collected data by the data transfer and management methods of the present invention to the format of the existing database using database format designations provided by the user to the data manager. The reformatted data is then uploaded to the user's existing database. If the existing database is not accessible to the data manager, the reformatted collected data is transferred to a storage location accessible to the data manager for later uploading to the user's database. For example, the reformatted data may be stored on a removable data storage medium that is in communication with a portable RFID reader, and that data storage medium can be used to import or upload the data to the existing database at any appropriate time.

In another embodiment, an RFID reader may be used to collect data without using information supplied by the user. In order to reformat the collected data to a format compatible with the existing database, the user first designates to the data manager the format in which the data exists in the existing database (to which the user intends to upload the collected information), or designates the format in which the existing database expects to receive the data. The reformatting of the collected data by the data manager and uploading of the reformatted collected data to the existing database occurs as described above.

In some cases the existing database management system may not be capable of directly uploading the reformatted collected data from data files. In such cases, the user may upload the reformatted collected data to the existing database via a software keyboard wedge. This is a software application that can run on a computer that is operating the existing database client application or a terminal emulator connected to the user's database. The purpose of the software keyboard wedge application is to read data from a file on the computer and translate the data in the file into keyboard input which can be accepted by another program running on the computer, in this case the database client application or terminal emulator. To use the software keyboard wedge, the user would first set the database client application or terminal emulator to accept input, for example identifiers. Then the software keyboard wedge would be activated and configured to provide data from the data file into the application in focus or another application. In this case the target is the database client application or terminal emulator. The operation will appear to the database as if the item information had been entered manually at the keyboard by the user.

D. Categorization of Data

In one aspect of the present invention, data that has been collected may be sorted into categories for storage in a database. A category, as that term is used herein, is a group of items that possess specified attributes, and represents only a portion (though perhaps a major portion) of an entire group of RFID-tagged items. Certain default categories may be provided that are believed to be of interest to the user, or the user may define the attributes of items that fall within a category or categories. For example, if the user uses the data manager in a library, the default categories may be locations within the library (reference, non-fiction, or fiction), or types of items (books, periodicals, audio/video, etc.). Defined or customized categories could include those for items that are believed to have been used in a certain manner (such as used inside the library but not checked out, or used for classroom or program purposes, or in connection with audio or video players), or other categories designed by a user for a specific application. These categories may be defined for or provided to the data manager through a user interface such as a keyboard, or a display having data entry capabilities, or by uploading from a removable data storage medium, or by uploading from a computer database that is linked to the data manager.

Once certain categories have been selected or defined, the categorization may be done in several ways. A first way of categorizing RFID-tagged items is to select (for example, from a list of categories displayed for the user) or define a category, obtain a list of RFID-tagged items, and then save the information related to those RFID-tagged items within a category to which they belong. This associates the RFID-tagged items with the category or categories. As an example, a user in a library may select or define a category for “used inside library but not checked out,” then obtain a list of RFID-tagged items (at least some of which were indicated when interrogated as having been used inside the library but not checked out), and then save that information within the “in-house use” category on a database. If the user then wishes to change categories, the user may select or define another category (“used in children's reading room,” for example), and obtain a list of interrogated items and save the appropriate ones within that category on a database.

A second way of categorizing RFID-tagged items is to select or define at least two categories, obtain a list of RFID-tagged items, and then to associate each item on the list with one or more of the categories. That is, categories may be created for different types of items, or for items having a different inventory status (present and absent, for example), or for items that have been recently interrogated (and thus may be a frequently used item) or not. The RFID-tagged items may be categorized in none, one, or more than one of the categories, depending on whether or not each item has the attributes of the items to be categorized in each respective category. The categories may be mutually exclusive (meaning that every RFID-tagged item may be categorized in only one category) or not.

A third way of categorizing RFID-tagged items is to select at least one category of items, obtain a list of RFID-tagged items, at least one of which is within the category of items, and then associate the RFID-tagged items with the appropriate category. That is, the data manager would associate items that have certain attributes with a certain category, and ignore any item on the list that does not have those attributes. Thus if a user were only interested in items having certain characteristics, the data manager could create a list of only those items, without listing or categorizing any other items that didn't have the specified characteristics. For example, if a user in a library were only interested in obtaining a list of items of a certain type, such as reference texts, a category for reference texts could be created, a list of interrogated RFID-tagged items obtained, and then only reference texts categorized in that category by the data manager. The information necessary to categorize each RFID-tagged item (in this and other embodiments) may be obtained from the list of RFID-tagged items, or from a database that includes a record related to that RFID tag and/or the item.

Categories, or categorized data, may be used in one or more different ways. One way is to create categories using the data manager, and then to export those categories to an RFID reader, such as a portable RFID reader. Those categories can then be selected by a user, so that RFID-tagged items that are interrogated are automatically categorized in one or more categories, as described above. Another way is to obtain or create categorized data describing items of interest using the data manager, and then to export the categorized data to an RFID reader, such as a portable RFID reader. The RFID reader then has access to the categorized data for use when it interrogates RFID-tagged items. A third way, which is exemplified above, is for the data manager to receive uncategorized data related to RFID-tagged items of interest (perhaps from an RFID reader, such as a portable RFID reader) and then to categorize it. That data may be obtained from a database, or from an RFID reader such as a portable RFID reader.

E. Ordering Collected Data

It may also be useful to conduct inventory using an RFID reader and RFID tags associated with items of interest. An RFID reader collects information related to the items by interrogating the RFID tags associated with the items. However, if this information is simply listed in a database in the order that the items were interrogated, and if a single item is out of place by, for example, 1000 items, then when that “interrogation list” is compared against a predetermined ordered list, the result may indicate that the intervening 1000 items are out of position by at least one place. For example, if in a library a book is out of position because it is 1000 books to the left of its proper position, then the interrogated list may indicate that the 1000 intervening books are all out of position. Alternatively, because an RFID reader may mistake the locations of two or more items while interrogating the RFID tags associated with those items, false storage locations errors may be indicated when none exist. These events may result in a paper printout or a data listing that is inconveniently large, and thus of little use to a user. Also, some users are not concerned about items that are out of position by only a few positions. This can be fairly common and doesn't typically present a problem for someone who is searching for the item, because the item is sufficiently near its expected location. A standard inventory report, however, may list all items that are out of position at all, even those only out of order by a small amount.

There are other devices, such as handheld RFID readers, that report errors in storage locations for items. For those who use such a device, an inventory report that describes errors in location as well as the presence or absence of items may not be useful. Those users may prefer to focus on other categories of information in their reports, such as items that are missing.

To overcome these potential difficulties, a method is provided whereby the data associated with RFID-tagged items that have been interrogated is placed in order according to their expected order (which may be referred to as an algorithm order). That ordered list may then be compared against a predetermined ordered list of items (or a predetermined list of items in algorithm order). This comparison enables a processor to determine which items that an RFID reader was expected to have interrogated are missing, and which items that an RFID reader was not expected to have interrogated (because a database indicates that they were not present) are present. The resulting lists of (unexpectedly) missing and (unexpectedly) present items, for example, are typically of a usable length, and accordingly, overcome the difficulties described above. These lists may be used to update the status of items that were unexpectedly missing or unexpectedly present according to an existing database, either by a user or automatically.

It is useful to place a list of RFID-tagged items in order prior to exporting or uploading the data to an existing database that includes records related to those items. There are several ways to accomplish this ordering process. If an RFID reader is equipped with a database that includes a list of items and their expected storage area location, then the RFID reader itself can store the data collected from RFID-tagged items using that database to order the collected data. Additionally, the RFID reader could use its database of items and their expected storage area locations to determine the expected location of each interrogated item, and associate the newly acquired and stored item information with that expected location, so that when the collected data is imported into the data manager, the data manager can use the associated expected location information to order the interrogated data as or after it is imported. Alternatively, the RFID reader may simply collect the data from the RFID-tagged items that it interrogates, store that data, and then export that data to the data manager for comparison to a predetermined ordered list. The data manager may compare the list of RFID-tagged items to a predetermined list stored by, or transferred or accessible to, the data manager. The data manager could also receive the list of RFID-tagged items and place those items in an order based on item identifier, serial number, alphabetical order, or other ordering criteria. In this and other applications, the order may be conventional in relationship to the items about which information is being sought (such as the Dewey Decimal system or the Library of Congress system for library materials), or may be designated by the user. Any or all of the lists described may be saved in a database, which may reside in the memory of a computer associated with the data manager, or on a removable data storage medium, or in memory associated with a separate computer or device.

F. Variations of the Invention

The data transfer and management system of the present invention may also be used in conjunction with devices other than a portable RFID reader. For example, self-service terminals and staff workstations for processing tagged items, such as those sold by the assignee of the present invention under the designation “Digital SelfCheck™ System” and “Digital Staff Workstation,” may also use data transferred to either or both of them in the manner described herein. Stations for converting barcoded items to RFID-tagged items, such as those sold by the assignee of the present invention under the designation “Digital Conversion Station” may also be used with the system of the present invention. Optical character recognition systems, manual entry systems, and list-based conversion systems may also be used. In that manner, items being processed by hardware other than a portable reader could also be checked against inventory or other lists, and handled appropriately.

Although RFID and non-RFID systems are not in general interchangeable, the present invention lends itself to non-RFID systems also. That is, barcode, optical character recognition (OCR), handwriting, or other readers and systems could be effectively substituted for RFID-based systems of the type described herein. In that manner, information stored in a database could be designated, reformatted, exported, and used by a barcode or OCR-based system in the same manner as with an RFID system, despite the obvious differences between RFID-based and optically-based identification systems, because the specific type of interrogation system is less important than the data transfer and management systems of the present invention. This would enable someone using a barcode or OCR scanner to search for particular items among a group of items, for example. Barcode and OCR scanners and systems are well known in the art.

Another useful embodiment of the present invention is its application to a system, such as an RFID tag converting device, that is used to convert an item that is identified in a manner other than by RFID tag to an item that is identified by an RFID tag. This is particularly useful where information to be incorporated into the RFID tag for the item to be converted is contained in an existing database, rather than on an identification means attached to the item, such as a bar-code or optical characters that can be read by an OCR device. For example, the item may be identified by a call number associated with the item and stored in a database, or by its name or title, or by another identifier. In one embodiment of this aspect of the invention, information identifying certain desired items is obtained from the existing database. This may be a list of items to be converted to RFID-tagged items, or another list of interest to a user. The information in the list is then reformatted in a desired manner, as described elsewhere herein, and then exported to a data storage device, such as a compact flash card as described above. The information on the data storage device can then be used in conjunction with an RFID tag converting device that displays the list of items to be converted (if that is the use to which the information will be put), and provides a user interface that enables a user to select an item to be converted or otherwise processed. The user interface could be or include a touch-panel display, a keyboard, a mouse, or a mouse button. If the item is being converted to an RFID-tagged item, then the information related to the item selected can be written to an RFID) tag by an RFID device and placed on or in the item.

The items described herein may be library materials, but may also be files (of the type commonly used to store paper, as opposed to electronic files), patient or client records, assets, retail and consumer goods, pallets or containers, or other similar items.

We claim:

1. A method of transferring and using information, comprising the steps of:
(a) obtaining information related to a plurality of items from an existing database;
(b) reformatting the information in a desired manner to facilitate the use of the information by an RFID reader;
(c) exporting the information to a database stored on a data storage device; and
(d) using the information on the data storage device with an RFID reader in conjunction with the interrogation of RFID tags associated with the items.

2. The method of claim 1, wherein the existing database includes information correlating the items to item identifiers.

3. The method of claim 2, wherein the item identifiers comprise barcodes.

4. The method of claim 2, wherein the item identifiers comprise at least one of characters and handwriting.

5. The method of claim 1, wherein the information exported to the data storage device comprises at least one ordered list of items.

6. The method of claim 5, wherein the ordered list is a list of items in an order that the items are to be located in a storage area.

7. The method of claim 1, wherein the information exported to the data storage device comprises at least one search list of items.

8. The method of claim 1, wherein the data storage device is a removable nonvolatile data storage device.

9. The method of claim 8, wherein the removable non-volatile data storage device is a solid-state device.

10. The method of claim 9, wherein the removable non-volatile solid-state data storage device is a compact flash memory card.

11. The method of claim 1, wherein the information exported to the data storage device comprises more than one file, each file including at least one database record.

12. The method of claim 11, wherein the method further comprises the step of associating at least two files that include information describing database records related to consecutive items in an ordered list.

13. The method of claim 11, wherein the method further comprises the step of determining that two files do not include information describing database records related to consecutive items.

14. The method of claim 1, wherein the information is reformatted by selecting from each record in the existing database information to be provided in a primary information field and information to be provided in a secondary information field on the database on the data storage device.

15. The method of claim 14, wherein at least one of the information fields comprises information from a record related to a single type of information.

16. The method of claim 14, wherein at least one of the information fields comprises information from a record related to more than one type of information.

17. The method of claim 14, wherein at least one of the information fields comprises information from a record in the existing database that represents only a portion of the information contained in that record.

18. The method of claim 14, wherein the information selected for the primary and secondary information fields is selected from the group consisting of the name or title of the item, the identification number of the item, or the call number of the item.

19. The method of claim 14, wherein the method further comprises the step of displaying information obtained from the primary information field and information obtained from the secondary information field on the RFID device for observation by a user.

20. The method of claim 1, wherein the step of reformatting the data comprises identifying multiple records in the existing database that relate to equivalent items.

21. The method of claim 20, wherein the method further comprises the step of providing only one entry on the database stored on the data storage device relative to that item.

22. The method of claim 20, wherein the method further comprises the step of comparing multiple entries from the existing database to determine whether the multiple entries relate to equivalent items using at least one of a primary information field and a secondary information field.

23. The method of claim 1, wherein the step of reformatting the data comprises identifying multiple records in the existing database that relate to equivalent items.

24. The method of claim 23, wherein the method further comprises the step of assigning the same storage area location to each identical item.

25. The method of claim 23, wherein the method further comprises the step of assigning a range of storage area locations to each identical item, so that each such item located within the range by the RFID device is considered by the device to be in the proper location.

26. The method of claim 1, wherein the method further comprises the step of previewing the format of at least one entry for the database on the data storage device prior to step (c).

27. The method of claim 26, wherein the entry includes information selected from the group consisting of an item identifier, a primary information field, a secondary information field, and a barcode.

28. The method of claim 1, wherein the method further comprises the step of providing a summary log related to the exportation of information.

29. The method of claim 28, wherein the summary log comprises information selected from a group consisting of a description of the files that were exported, the number of entries that were exported, the elapsed time for the transfer, and the number of errors encountered during the export.

30. The method of claim 28, wherein the method further comprises providing a detailed error log that provides information related to errors detected in the exported information.

31. The method of any one of claims 1 through 30, wherein the items are library materials.

32. The method of any one of claims 1 through 30, wherein the items are files.

33. The method of any one of claims 1 through 30, wherein the items are pieces of evidence.

34. The method of any one of claims 1 through 30, wherein the items are pallets or containers.

35. Software comprising instructions for carrying out the method of any of claims 1 through 30.

36. In combination:
(a) software for reformatting information obtained from an existing database having an arbitrary data management system into reformatted information stored in a database for use by an RFID reader, the databases comprising entries related to items of interest; and
(b) an RFID reader that interrogates RFID tags associated with items and transfers information related to the interrogated RFID-tagged item from the RFID reader to the database, from the database to the RFID reader, or both.

37. The combination of claim 36, wherein the RFID reader is a handheld RFID reader.

38. The combination of claim 36, wherein the RFID reader is a component of a workstation for processing items selected by users.

39. The combination of claim 38, wherein the workstation is a workstation adapted for use by a library employee.

40. The combination of claim 38, wherein the workstation is a self-service station adapted for use by the user who selected the items.

41. The combination of claim 38, wherein the workstation is a conversion station for converting non-RFID-tagged items to RFID-tagged items.

42. The combination of claim 41, wherein the non-RFID-tagged items are barcoded items.

43. The combination of claim 41, wherein the non-RFID-tagged items are identified by characters.

44. The combination of claim 41, wherein the non-RFID-tagged items are items regarding which a user enters information describing the items into the workstation.

45. A method of using information related to RFID tags associated with items of interest, comprising the steps of:
(a) selecting a category of items using a user interface associated with a computer;
(b) obtaining a list of at least one RFID-tagged item; and
(c) associating information related to the at least one item with the selected category.

46. The method of claim 45, wherein the method further includes the step of:
(d) saving the categorized information in a database.

47. The method of claim 46, wherein step (a) comprises selecting a category from among a list of categories displayed on the user interface.

48. The method of claim 46, wherein step (a) comprising selecting a category and designating the attributes of items in that category to define the category.

49. The method of claim 46, wherein the category describes a location where an item was interrogated.

50. The method of claim 46, wherein the category describes a class of items.

51. The method of claim 46, wherein categories from which a user may select are uploaded from a data storage device and displayed on the user interface.

52. A method of interrogating RFID tags associated with items of interest, comprising the steps of:
(a) selecting at least two categories of items using a user interface associated with a computer;
(b) obtaining a list of at least one RFID-tagged item; and
(c) categorizing information related to the at least one item(s) associated with the interrogated RFID tag(s) in at least one of the categories.

53. The method of claim 52, wherein the method further includes the step of:
(d) saving the categorized information in a database.

54. The method of claim 53, wherein the categories are mutually exclusive.

55. The method of claim 53, wherein the categories are not mutually exclusive.

56. The method of claim 53, wherein one category describes whether an item is present in a storage area.

57. The method of claim 53, wherein the categories describe different types of items.

58. The method of claim 53, wherein information necessary to categorize each RFID-tagged item may be obtained from a database stored in memory of the RFID reader.

59. The method of claim 58, wherein the database is stored on a removable data storage device.

60. A method of interrogating RFID tags associated with items of interest, comprising the steps of:
(a) selecting at least one category of items using a user interface associated with an RFID reader;
(b) interrogating RFID tags associated with items, at least one of which is within the category of items;
(c) categorizing information related to the at least one item(s) associated with the interrogated RFID tag(s) in at least one of the categories; and
(d) ignoring any RFID-tagged-item that may not be categorized in at least one category.

61. The method of claim 60, wherein the method further includes the step of:
(e) saving the categorized information in a database.

62. The method of claim 61, wherein at least one category describes items of a certain type.

63. The method of claim 61, wherein the database is stored on a removable data storage device.

64. A method of using information related to items associated with RFID tags, comprising the steps of:
(a) obtaining a list of information related to the RFID tags, the list organized in the order in which the RFID tags were interrogated by an RFID reader; and
(b) organizing the information in an order other than the order in which the tags were interrogated by the RFID reader.

65. The method of claim 64, wherein only information related to RFID-tagged items that are out of position by at least a predetermined amount is organized in the order.

66. The method of claim 64, wherein the method further includes the step of:
(c) comparing the organized information from step (b) with a predetermined ordered list.

67. The method of claim 66, wherein the predetermined ordered list is a list of items in an expected order of location in a storage area.

68. The method of claim 66, wherein the method further comprises the step of:
(d) creating a list of items that are on the predetermined ordered list but not among the ordered list from step (b).

69. The method of claim 66, wherein the method further comprises the step of:
(d) creating a list of items that are on the ordered list from step (b) but not among the predetermined ordered list.

70. The method of claim 66, wherein both the ordered list of step (b) and the predetermined ordered list are provided to a computer by a portable RFID reader.

71. The method of claim 66, wherein both the ordered list of step (b) and the predetermined ordered list are stored on a removable data storage device by a portable RFID reader, and uploaded from the removable data storage device to a computer.

72. A method of transferring and using information, comprising the steps of:
(a) obtaining information related to a plurality of items from an existing database;
(b) reformatting the information in a desired manner to facilitate the use of the information by an RFID tag conversion device;
(c) exporting the information to a database stored on a data storage device; and
(d) using the information on the data storage device with an RFID tag conversion device to write information to an RFID tag.

73. The method of claim 72, wherein the information written to an RFID tag corresponds to a selected item of the plurality of items.

74. The method of claim 72 or 73, wherein the method further includes the step of (e) placing the RFID tag on or in the item.

75. The method of claim 72, wherein the existing database includes information correlating the items to item identifiers.

76. The method of claim 72, wherein the item identifiers comprise barcodes.

77. The method of claim 72, wherein the item identifiers comprise at least one of characters and handwriting.

78. The method of claim 72, wherein the information exported to the data storage device comprises at least one list of items to be converted to RFID tagged items.

79. The method of claim 78, wherein the list is a list of items in an order that the items are to be located in a storage area.

80. The method of claim 72, wherein the data storage device is a removable nonvolatile data storage device.

81. The method of claim 80, wherein the removable non-volatile data storage device is a solid-state device.

82. The method of claim 81, wherein the removable non-volatile solid-state data storage device is a compact flash memory card.

83. The method of claim 72, wherein the information exported to the data storage device comprises more than one file, each file including at least one database record.

84. The method of claim 72, wherein the information is reformatted by selecting from each record in the existing database information to be provided in a primary information field and information to be provided in a secondary information field in the database on the data storage device.

85. The method of claim 84, wherein at least one of the information fields comprises information from a record related to a single type of information.

86. The method of claim 84, wherein at least one of the information fields comprises information from a record related to more than one type of information.

87. The method of claim 84, wherein at least one of the information fields comprises information from a record in the existing database that represents only a portion of the information contained in that record.

88. The method of claim 84, wherein the information selected for the primary and secondary information fields is selected from the group consisting of the name or title of the item, the identification number of the item, or the call number of the item.

89. The method of claim 84, wherein the method further comprises the step of displaying information obtained from the primary information field and information obtained from the secondary information field on the RFID tag conversion device for observation by a user.

90. The method of claim 72, wherein the step of reformatting the data comprises identifying multiple records in the existing database that relate to equivalent items.

91. The method of claim 90, wherein the method further comprises the step of providing only one entry on the database stored on the data storage device relative to that item.

92. The method of claim 90, wherein the method further comprises the step of comparing multiple entries from the existing database to determine whether the multiple entries relate to equivalent items using at least one of a primary information field and a secondary information field.

93. The method of claim 72, wherein the step of reformatting the data comprises identifying multiple records in the existing database that relate to equivalent items.

94. The method of claim 93, wherein the method further comprises the step of assigning the same storage area location to each identical item.

95. The method of claim 72, wherein the method further comprises the step of previewing the format of at least one entry for the database on the data storage device prior to step (c).

96. The method of claim 95, wherein the entry includes information selected from the group consisting of an item identifier, a primary information field, a secondary information field, and a barcode.

97. The method of claim 72, wherein the method further comprises the step of providing a summary log related to the exportation of information.

98. The method of claim 97, wherein the summary log comprises information selected from a group consisting of a description of the files that were exported, the number of entries that were exported, the elapsed time for the transfer, and the number of errors encountered during the export.

99. The method of claim 97, wherein the method further comprises providing a detailed error log that provides information related to errors detected in the exported information.

100. The method of any one of claims 72 through 99, wherein the items are library materials.

101. The method of any one of claims 72 through 99, wherein the items are files.

102. The method of any one of claims 72 through 99, wherein the items are pieces of evidence.

103. The method of any one of claims 72 through 99, wherein the items are pallets or containers.

104. Software comprising instructions for carrying out the method of any of claims 72 through 99.

105. In combination:
(a) software for reformatting information obtained from an existing database having an arbitrary data management system into reformatted information stored in a database for use by an RFID tag conversion device, the databases comprising entries related to items of interest; and
(b) an RFID tag conversion device that writes information related to items of interest to RFID tags.

106. The combination of claim 105, wherein the RFID tag conversion device is a handheld RFID tag conversion device.

107. The combination of claim 105, wherein the RFID tag conversion device is a component of a workstation for processing items selected by users.

108. The combination of claim 107, wherein the workstation is a workstation adapted for use by a library employee.

109. The combination of claim 107, wherein the workstation is a self-service station adapted for use by the user who selected the items.

110. The combination of claim 107, wherein the workstation is a conversion station for converting non-RFID-tagged items to RFID-tagged items.

111. The combination of claim 110, wherein the non-RFID-tagged items are barcoded items.

112. The combination of claim 110, wherein the non-RFID-tagged items are identified by characters.

113. The combination of claim 110, wherein the non-RFID-tagged items are items regarding which a user enters information describing the items into the workstation.
